(19) United States
(12) Patent Application Publication
(10) Pub. No.: US 2013/0275043 A1
(43) Pub. Date: Oct. 17, 2013

(54) Location-Based Service System and Wishing Service Method Thereof

(71) Applicants: MITAC INTERNATIONAL CORP., Kuei San Township (TW); MITAC RESEARCH (SHANGHAI) LTD., Shanghai (CN)

(72) Inventor: Zhu Chen, Shanghai City (CN)

(73) Assignees: MiTAC Research (Shanghai) Ltd., Shanghai (CN); MiTAC International Corp., Kuei San Township (TW)

(21) Appl. No.: 13/750,412

(22) Filed: Jan. 25, 2013

(30) Foreign Application Priority Data
Apr. 12, 2012 (CN) 201210106954.1

(51) Int. Cl. G01C 21/00

(52) U.S. Cl. CPC G01C 21/00
USPC 701/487

(57) ABSTRACT

A location-based service (LBS) system and a wishing service method thereof, including a user's equipment end, a server and a merchant's equipment end. The user equipment receives current location information of the user's equipment end and a user's wishing message and transmits them to the server. The server analyzes a wishing category of the user's wishing message and issues the user's wishing message to a region range of the corresponding current location information. The merchant's equipment end receives the user's wishing message in the region range according to the wishing category, and transmits a merchant's feedback message to the server according to the user's wishing message. Wherein, the server receives the merchant's feedback message to be transmitted to the user's equipment end, and the user's equipment end receives the merchant's feedback message through the server to automatically guide to a position corresponding to merchant's location.

### CROSS-REFERENCE TO RELATED APPLICATION

This application claims the benefit of China Patent Application No. 201210106954.1, filed on Apr. 12, 2012, in the State Intellectual Property Office of the People's Republic of China, the disclosure of which is incorporated herein in its entirety by reference.

### BACKGROUND OF THE INVENTION

1. Field of the Invention

The present invention relates to a location-based service system, and more particularly to the location-based service system and a wishing service method thereof provided for users to input a desired wish, so that a merchant can confirm whether or not to provide a service.

2. Description of Related Art

Location-based service (LBS) is also known as appropriate location service, mobile location service, location service, or locating service. As the names suggest, the location-based service is a service based on a geographical position to determine whether to provide users a service, and the location-based service primarily accesses location information (or geographical coordinates of a mobile terminal user through a wireless communication network or external positioning method of a mobile telecommunication company. Wherein, the wireless telecommunication network includes global system for mobile communications (GSM) or code division multiple access (CDMA); and the external positioning method includes global positioning system (GPS).

Nowadays, people pay much attention on leisure activities, and usually seek for related information including lodging, meals, scenic spots, tourist guides or other services through the Internet actively when they want to visit a foreign place, or browse the evaluation of merchants or read other travelers' notes from related tour forums on the Internet as a reference. However, appropriate service information for an urgent need occurred during a sudden or unexpected situation cannot be fulfilled in a timely manner. In the meantime, the service provided by merchants may require a sharing with others, so that the user has to give up the service if the number of people is insufficient at the time.

As science and technology advance, a general navigator provided for users to plan a path only is gradually being developed into a navigator that is integrated with the Internet. Therefore, if the navigator combined with the location-based service can seek for a merchant's service according to the user's current position and the user's wish for a personal trip, and the merchant can actively provide a required customer base, such arrangement not only facilitates the users to find their desired service, but also benefits the merchants as well.

Therefore, it is an urgent issue for related designers to design a location-based service system and a wishing service method for users to input a wish in order to obtain a service corresponding to a merchant's feedback message according to the user's wish and guide the user to the location of the merchant.

### SUMMARY OF THE INVENTION

In view of the aforementioned problems of the prior art, it is a primary objective of the present invention to provide a location-based service system and a wishing service method thereof, so that users can search for a merchant easily and obtain an immediate service according to the user requirements.

To achieve the foregoing objective, the present invention provides a location-based service (LBS) system that provides a wishing service to a user, and the service system comprises: a user's equipment end, a server and a merchant's equipment end. The user's equipment end is provided for receiving current location information of the user's equipment end through a global positioning system, receiving a user's wishing message inputted by a user, and transmitting the current location information and the user's wishing message. The server is provided for receiving the current location information of the user's equipment end and the user's wishing message, analyzing a wishing category of the user's wishing message, and issuing the user's wishing message to a region range of the corresponding current location information. The merchant's equipment end is provided for receiving the user's wishing message in the region range according to the wishing category, and transmitting a merchant's feedback message to the server according to the user's wishing message. Wherein, the server receives the merchant's feedback message, and transmits the merchant's feedback message to the user's equipment end, and the user's equipment end receives the merchant's feedback message through the server to automatically guide the user to a position corresponding to the merchant's location information of the merchant's equipment end.

Wherein, the merchant's feedback message includes a merchant address or a merchant map of the merchant's location information.

Wherein, the user's equipment end computes a navigation route according to the current location information and the merchant's location information to provide a path to the user.

Wherein, the user's equipment end receives a user's input selected from a collection of a willing-to-pay amount, a distance of the current location information, a predetermined time, a desired wish, and any combination of the above.

Wherein, the merchant's equipment end determines to transmit the merchant's feedback message to the server according to the user's equipment end's willing-to-pay amount, distance of the current location information, predetermined time, desired wish or any combination of the above.

Wherein, the merchant's equipment end receives a merchant's activity message inputted by a merchant, and transmits the merchant's activity message and the merchant's location information to the server.

Wherein, the server receives the merchant's activity message, and analyzes the wishing category of the merchant's activity message to issue the merchant's activity message to the region range corresponding to the merchant's location information.

Wherein, the user's equipment end receives the merchant's activity message within the region range according to the wishing category, and transmits a user's willing-to-participate message to the server according to the merchant's activity message.

Wherein, the server receives the user's willing-to-participate message inputted by the user's equipment end and transmits the user's willing-to-participate message to the merchant's equipment end, and the merchant's equipment end receives the user's willing-to-participate message through the server and provides the user's willing-to-particulate message to the merchant's equipment end to calculate statistics of the user's willingness.

To achieve the foregoing objective, the present invention further provides a wishing service method, applied in a location-based service system, and the service system comprises a user's equipment end, a server and a merchant's equipment end, and the wishing service method comprises the steps of: providing current location information of the user's equipment end received through a global positioning system; receiving a user's wishing message inputted by a user through the user's equipment end; transmitting the current location information and the user's wishing message from the user's equipment end; receiving the current location information of the user's equipment end and the user's wishing message by the server; analyzing a wishing category of the user's wishing message through the server; issuing the user's wishing message to a region range of the corresponding current location information through the server; receiving the user's wishing message within the region range and providing the user's wishing message to the merchant's equipment end according to the wishing category; transmitting a merchant's feedback message to the server from the merchant's equipment end according to the user's wishing message; transmitting the merchant's feedback message to the user's equipment end through the server; and receiving the merchant's feedback message by the user's equipment end to automatically guide the user to a position corresponding to the merchant's location information of the merchant's equipment end.

In summation, the location-based service system and the wishing service method of the present invention have one or more of the following advantages:

(1) The location-based service system and the wishing service method of the present invention are provided for users to input a desired wish and obtain a service of a merchant's feedback message according to the wish through a location-based service.

(2) The location-based service system and the wishing service method of the present invention are provided for users to obtain an instant service (to be satisfied within an hour) in compliance with the user's wish during unexpected situations and automatically plan a route from the user's current position to the merchant.

(3) The location-based service system and the wishing service method of the present invention are provided for users to actively submit a request to seek for a merchant, so as to increase the customer base, in addition to reducing the merchant's marketing cost.

The foregoing and other objectives, technical characteristics and advantages of the present invention will become apparent with the detailed description of preferred embodiments accompanied with related drawings as follows.

### BRIEF DESCRIPTION OF THE DRAWINGS

FIG. 1 is a block diagram of a service system of the present invention;

FIG. 2 is a first schematic view of a service system in accordance with a first preferred embodiment of the present invention;

FIG. 3 is a second schematic view of a service system in accordance with the first preferred embodiment of the present invention;

FIG. 4 is a third schematic view of a service system in accordance with the first preferred embodiment of the present invention;

FIG. 5 is a fourth schematic view of a service system in accordance with the first preferred embodiment of the present invention;

FIG. 6 is a fifth schematic view of a service system in accordance with the first preferred embodiment of the present invention;

FIG. 7 is a flow chart of a wishing service method in accordance with the first preferred embodiment of the present invention;

FIG. 8 is a block diagram of a service system in accordance with a second preferred embodiment of the present invention; and

FIG. 9 is a flow chart of a wishing service method in accordance with the second preferred embodiment of the present invention.

### DETAILED DESCRIPTION OF THE PREFERRED EMBODIMENTS

The technical characteristics of the location-based service system and the wishing service method will become apparent with the detailed description of preferred embodiments accompanied with related drawings as follows. It is noteworthy to point out that same numerals are used for representing the same respective elements in the following embodiments.

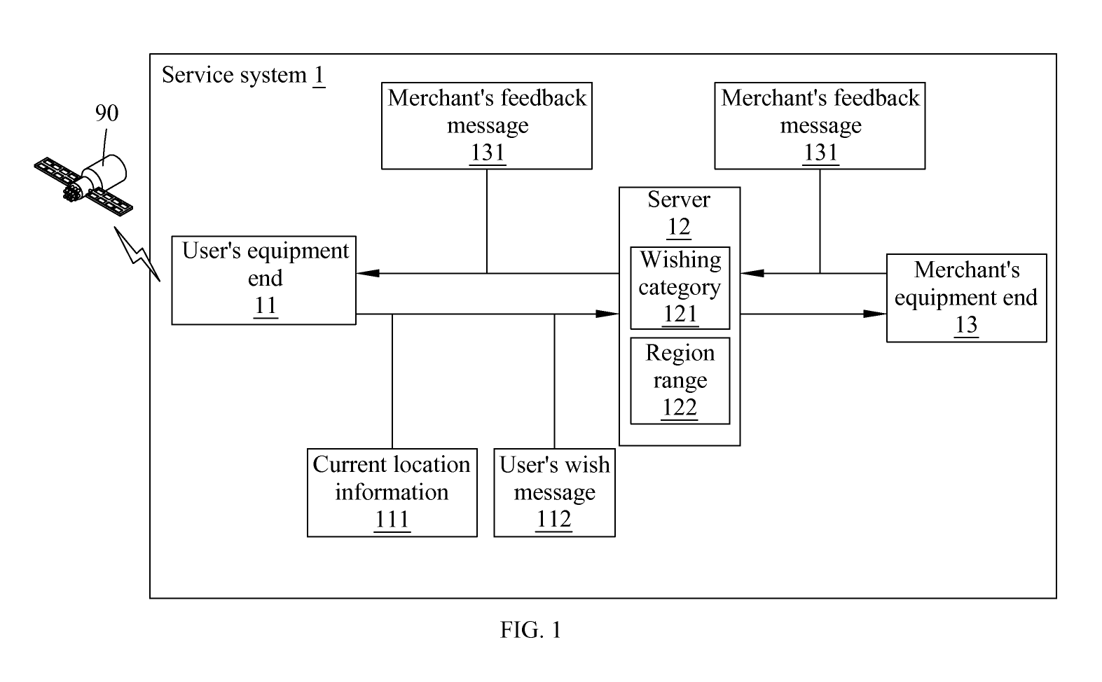

With reference to FIG. 1 for a block diagram of a location-based service system of the present invention, the location-based service system 1 comprises a user's equipment end 11, a server 12 and a merchant's equipment end 13. The user's equipment end 11 of the present invention is a tablet PC, a Smartphone, a personal digital assistant (PDA), a personal navigation device (PND) and a global positioning system for cars or a location-based service electronic device. To make it simple for our examiner to understand the technical characteristics of the present invention, PND is used for an example to illustrate the present invention, but the invention is not limited to such arrangement only. The user's equipment end 11 can receive current location information 111 of the user's equipment end 11 through a global positioning system (GPS) 90 for positioning. The user's equipment end 11 can receive a user's wishing message 112 inputted by a user, and transmit the current location information 111 and the user's wishing message 112. The server 12 can receive the current location information 111 of the user's equipment end 11 and the user's wishing message 112 inputted by the user through the Internet, and the server 12 can analyze a wishing category 121 of the user's wishing message 112 to issue the user's wishing message 112 to a region range 122 of the corresponding current location information 111. The merchant's equipment end 13 can be an electronic device such as a tablet PC, a Smartphone, a PDA, a personal computer (PC), but the present invention is not limited to these devices only. The merchant's equipment end 13 receives the user's wishing message 112 within the region range 122 according to the wishing category 121 and transmits a merchant's feedback message 131 to the server 12 according to the user's wishing message 112, and the merchant's feedback message 131 is transmitted from the server 12 to the user's equipment end 11. Wherein, the merchant's feedback message 131 can include merchant's location information such as a merchant address and a merchant map or discount information provided by the merchant.

It is noteworthy to point out that when the server 12 receives the merchant's feedback message 13 and transmits the merchant's feedback message 131 to the user's equipment end 11 synchronously, the user's equipment end 11 can automatically guide the user to the merchant's location information. The merchant's feedback message 131 includes merchant's location information such as a merchant address or a merchant map. In other words, the user's equipment end 11 can compute a navigation route according to the current location information 111 and the merchant's location information and provide the navigation route to the users.

In addition, the user's equipment end 11 can receive a user's input of a willing-to-pay amount, a distance of the current location information, a predetermined time, a desired wish or any combination of the above and issue the user's input to the server 12. The merchant's equipment end 13 can receive the user's input of the willing-to-pay amount, the distance of the current location information, the predetermined time, the desired wish or any combination of the above through the server 12 to determine whether or not to transmit the merchant's feedback message 131 to the server 12.

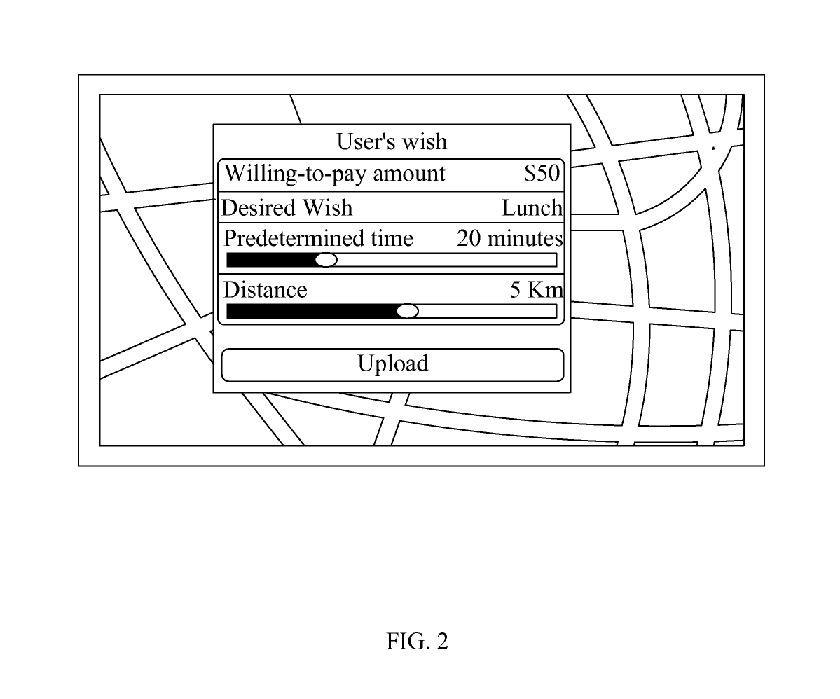

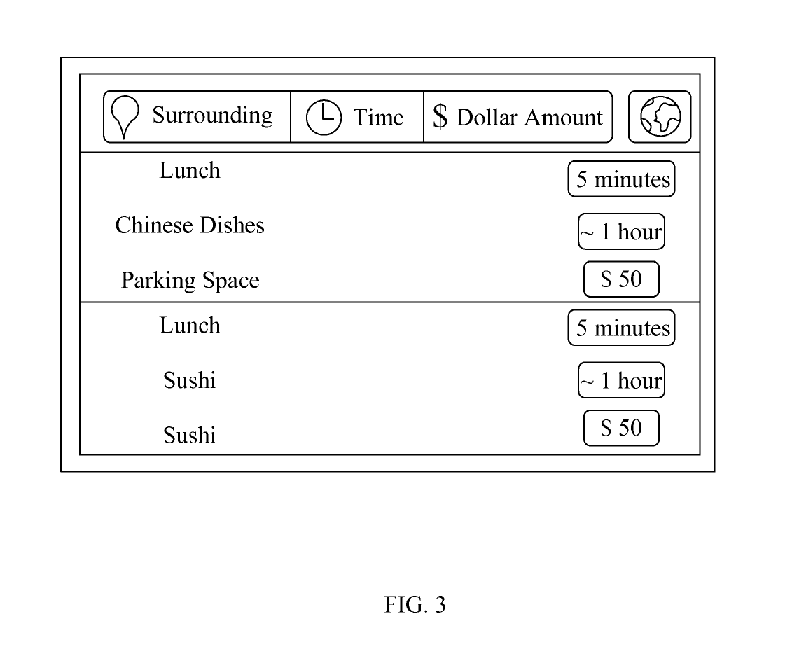

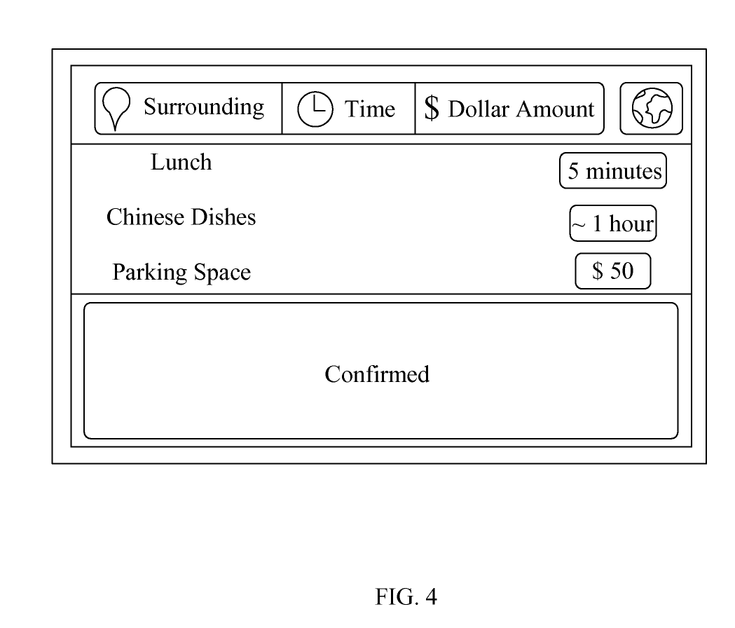

With reference to FIGS. 2 to 6 for the first to fifth schematic views of a service system in accordance with the first preferred embodiment of the present invention respectively, FIG. 2 shows that a user A travels to a certain place and wants to dine in the neighborhood of the current position. Therefore, the service system of the present invention can be used, and the user A can operate a PND to input a willing-to-pay amount equal to $50, a desired wish being lunch, a predetermined time being 20 minutes and a distance from the current position equal to 5 Km. After inputting the data, the user presses an upload key to transmit the inputted data to a server. In FIG. 3, after the server receives the user's wishing message set by the user A, the wishing category is analyzed and determined to be dining information, so that the server issues the user's wishing message to a dining information bulletin in a region range of the current position. Therefore, merchants situated within the region range can receive that most updated consumer service request. In other words, the merchant's equipment end can receive the wish requirements of the user A according to the dining information. Based on the set wish, a merchant B can confirm whether the service can be provided. If the merchant B confirms that the service can be provided, then the merchant's equipment end will transmit a merchant's feedback message to a server as shown in FIG. 4, and other information such as parking space or limited-time discount can be transmitted as well.

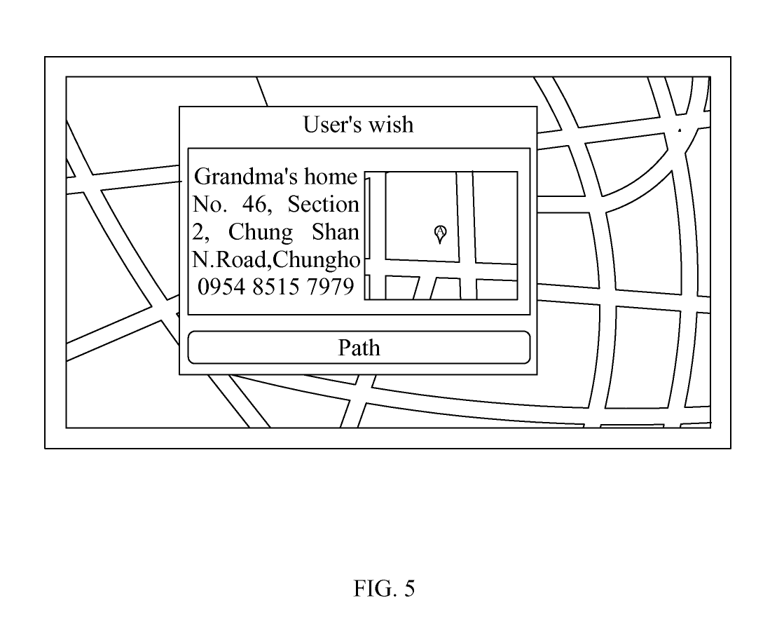

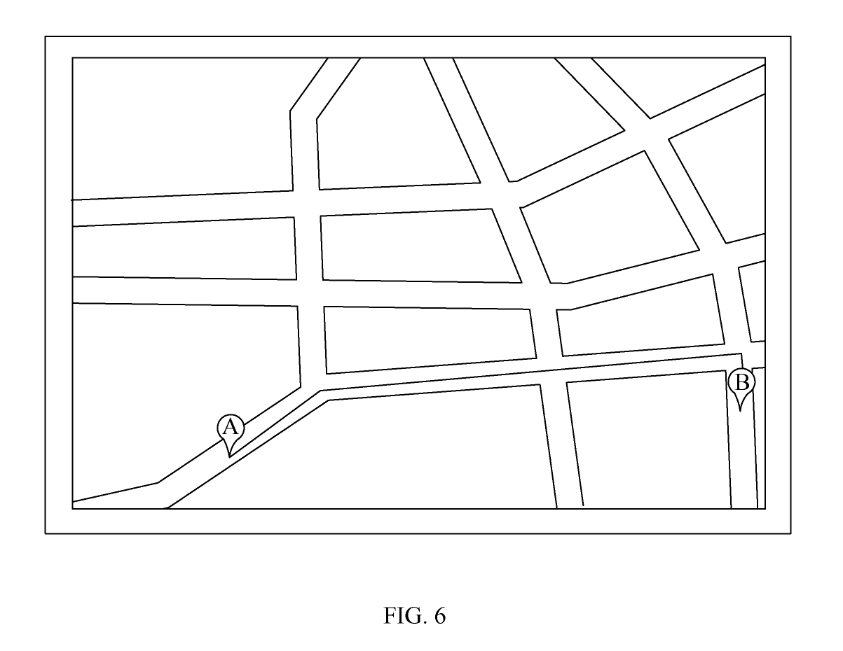

In FIG. 5, when the server receives the merchant's feedback message, the server can transmit the merchant's feedback message to the user's equipment end synchronously, so that the server can receive a merchant's feedback message replied by the merchant B. The user A can confirm to go. In FIG. 6, the PND can be used to plan a route from the current position of the user A to the position of the merchant B.

Even though the process of describing the service system of the present invention already clarifies the concept of the wishing service method of the present invention, the following flow chart is provided for illustrating the method more clearly.

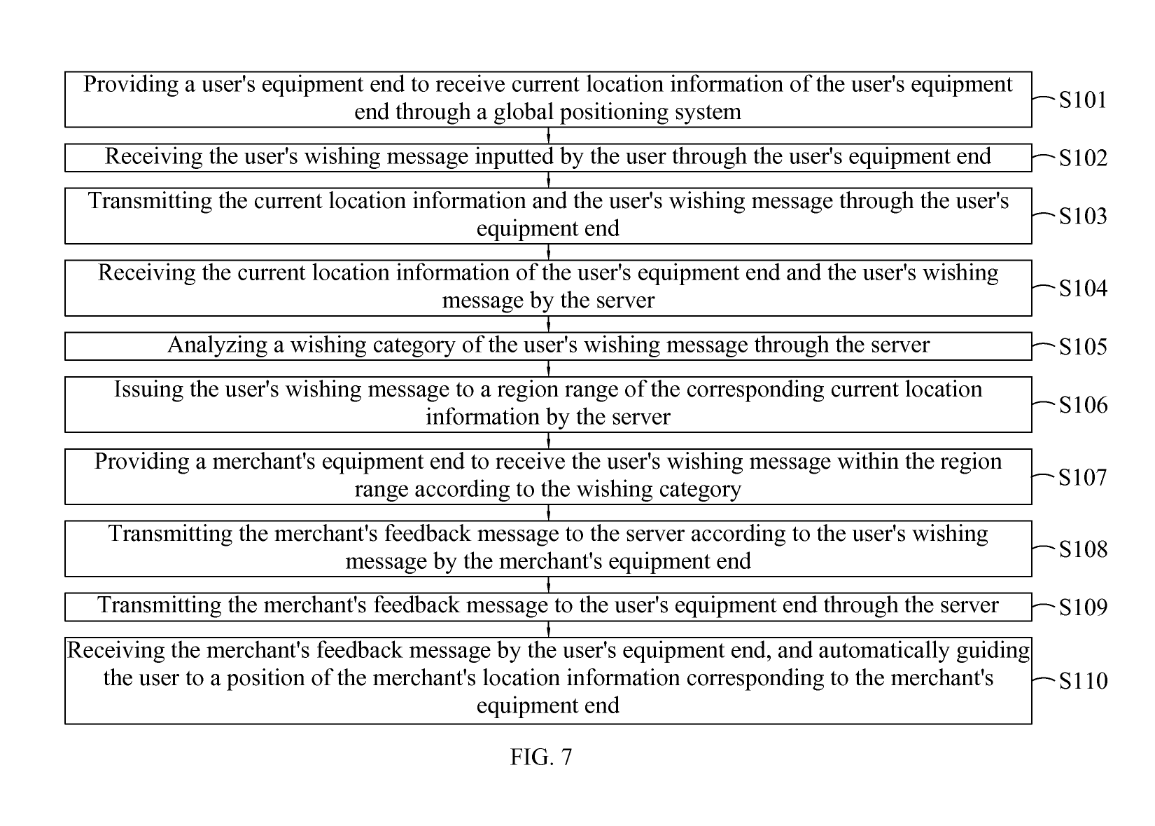

With reference to FIG. 7 for a flow chart of a wishing service method in accordance with the first preferred embodiment of the present invention, the wishing service method of a location-based service system comprises the following steps:

S101: Providing a user's equipment end to receive current location information of the user's equipment end through a global positioning system.

S102: Receiving the user's wishing message inputted by the user through the user's equipment end.

S103: Transmitting the current location information and the user's wishing message through the user's equipment end.

S104: Receiving the current location information of the user's equipment end and the user's wishing message by the server.

S105: Analyzing a wishing category of the user's wishing message through the server.

S106: Issuing the user's wishing message to a region range of the corresponding current location information by the server.

S107: Providing a merchant's equipment end to receive the user's wishing message within the region range according to the wishing category.

S108: Transmitting the merchant's feedback message to the server according to the user's wishing message by the merchant's equipment end.

S109: Transmitting the merchant's feedback message to the user's equipment end through the server.

S110: Receiving the merchant's feedback message by the user's equipment end, and automatically guide the user to a position of the merchant's location information corresponding to the merchant's equipment end.

The details and implementation of the wishing service method of a service system in accordance with the present invention have been described in the above section of the location-based service system of the present invention, and thus will not be repeated.

In the service system of the present invention, the user requirements are taken into consideration. Even if there is a sudden unexpected situation, the problem can be solved quickly. Meanwhile, the merchant can obtain the customer base quickly to provide a quick response to allow users to obtain the required service efficiently, while the merchant can expand the customer base and achieve effective advertising and marketing.

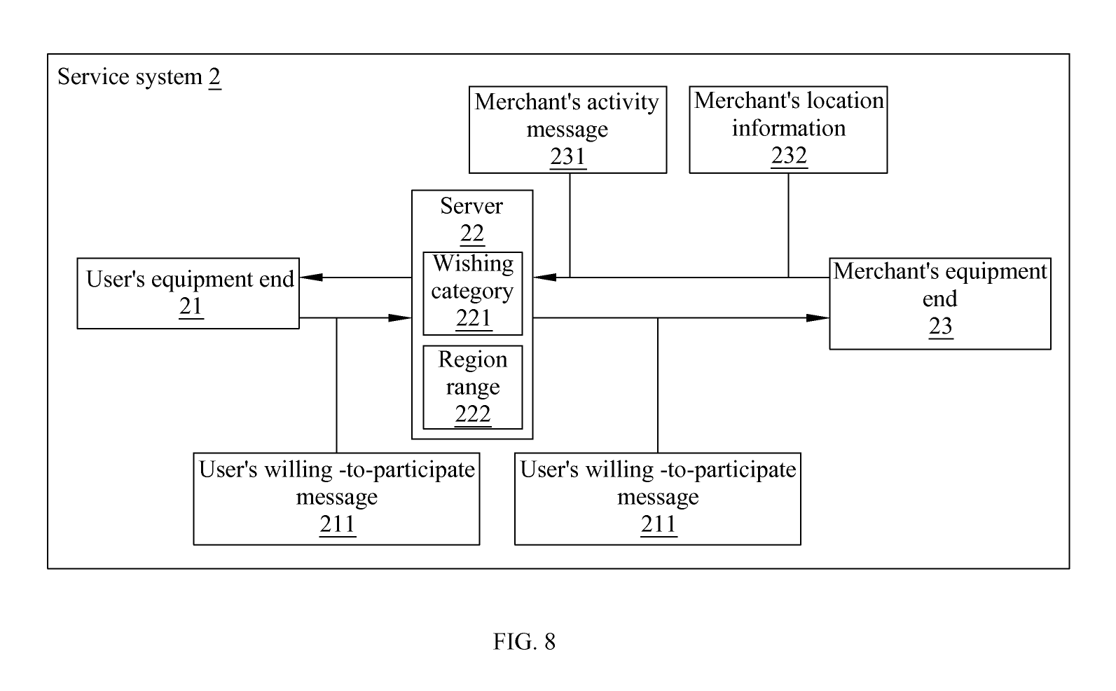

With reference to FIG. 8 for a block diagram of a service system in accordance with the second preferred embodiment of the present invention, the service system 2 allows a merchant to initiate an activity and call the users to join the activity. In FIG. 8, the location-based service system 2 comprises a user's equipment end 21, a server 22 and a merchant's equipment end 23.

The user's equipment end 21 of the present invention can be an electronic device such as a tablet PC, a Smartphone, a personal digital assistant (PDA), a personal navigation device (PND) and an automobile navigator used for navigation or having a location-based service. To make it easier to understand the technical characteristics of the present invention, the PND is used in the embodiment, but the invention is not limited to PND only. The merchant's equipment end 23 can be an electronic device such as a tablet PC, a Smartphone, a PDA, a personal computer (PC), but the invention is not limited to these devices only.

The merchant's equipment end 23 can receive a merchant's activity message 231 inputted by the merchant while the merchant's activity message 231 and the merchant's location information 232 are issued to the server 22 through the Internet. Through the Internet, the server 22 receives the merchant's activity message 231 and analyzes a wishing category 221 of the merchant's activity message 231 such as dining information, fashion information, hotel information or health information. In addition, the server 22 issues the merchant's activity message 231 to a region range 222 corresponding to the corresponding merchant's location information 232. The user's equipment end 21 receives the current location information of the user's equipment end 21 through the global positioning system and receives the merchant's activity message 231 within the region range 222 according to the wishing category 221. The user's equipment end 21 determines whether or not to transmit the user's willing-to-participate message 211 to the server 22 according to the merchant's activity message 231. When the server 22 receives a user's willing-to-participate message 211 replied from the user's equipment end 21, the server synchronously transmit the user's willing-to-participate message 211 to the merchant's equipment end 23, and the merchant's equipment end 23 receives the user's willing-to-participate message 211 through the server 22, and the user's willing-to-participate message 211 is provided for the merchant's equipment end 23 to count statistics of the user's willingness.

It is noteworthy to point out that the service system 2 of the present invention can be used by several persons simultaneously. Particularly, if a merchant issues an activity for many people, users can gather sufficient number of people to join the activity through the service system 2 of the present invention.

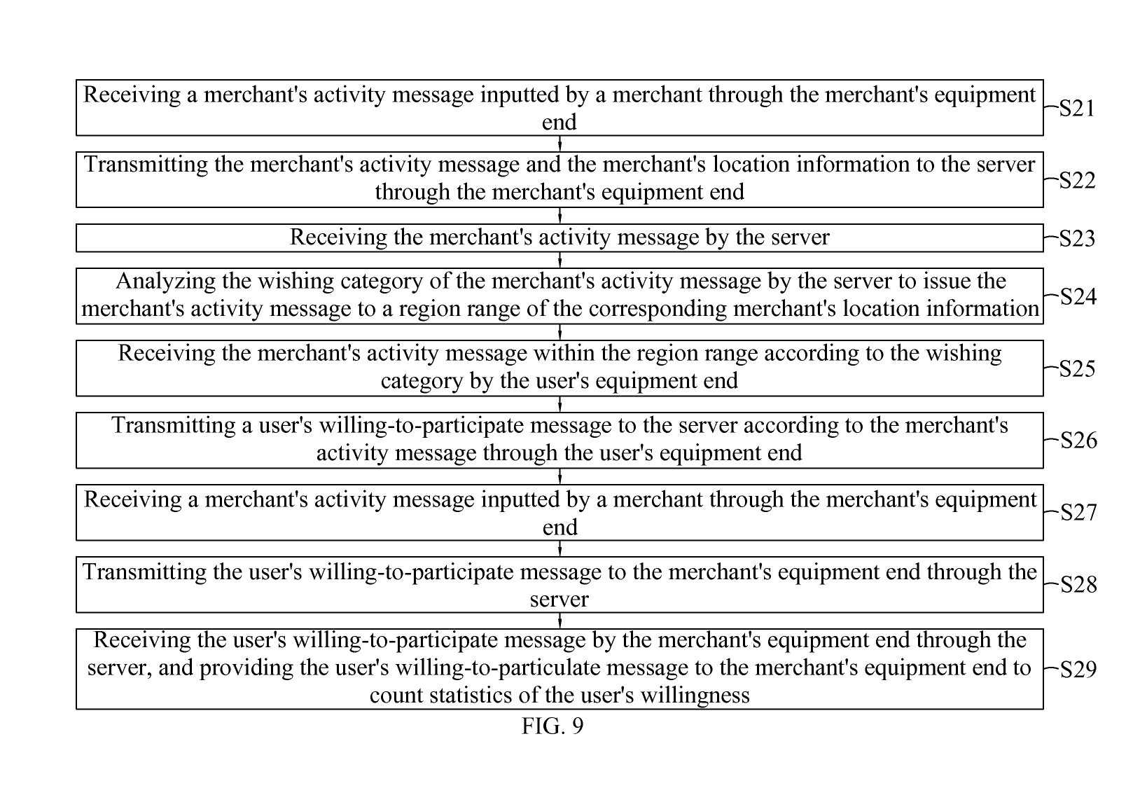

With reference to FIG. 9 for a flow chart of a wishing service method in accordance with the second preferred embodiment of the present invention, the wishing service method of a location-based service system comprises the following steps:

S21: Receiving a merchant's activity message inputted by a merchant through the merchant's equipment end.

S22: Transmitting the merchant's activity message and the merchant's location information to the server through the merchant's equipment end.

S23: Receiving the merchant's activity message by the server.

S24: Analyzing the wishing category of the merchant's activity message by the server to issue the merchant's activity message to a region range of the corresponding merchant's location information.

S25: Receiving the merchant's activity message within the region range according to the wishing category by the user's equipment end.

S26: Transmitting a user's willing-to-participate message to the server according to the merchant's activity message through the user's equipment end.

S27: Receiving the user's willing-to-participate message inputted by the user's equipment end through the server.

S28: Transmitting the user's willing-to-participate message to the merchant's equipment end through the server.

S29: Receiving the user's willing-to-participate message by the merchant's equipment end through the server, and providing the user's willing-to-particulate message to the merchant's equipment end to count statistics of the user's willingness.

The details and implementation of the wishing service method of the service system in accordance with the present invention have been described in the section of the location-based service system of the present invention already, and thus will not be repeated.

As to users, it is not necessary to actively search for information, but the users simply describe their wish, so that merchants can actively provide the service information. Even if there is a sudden unexpected situation (including a short notice for service within an hour), the service can be found in a timely manner. It is also noteworthy to point out that nearby users can be called by the service system to join an activity or other immediate wishes can be proposed. As to merchants, users can actively propose their wishes to seek a merchant, and such arrangement not only lowers the merchants' marketing cost, but also increases their customer base.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded with the broadest interpretation so as to encompass all such modifications and similar arrangements and procedures.

What is claimed is:

1. A location-based service (LBS) system providing a wishing service, comprising:
a user's equipment end, receiving current location information of the user's equipment end through a global positioning system, receiving a user's wishing message inputted by a user, and transmitting the current location information and the user's wishing message;
a server, receiving the current location information of the user's equipment end and the user's wishing message, analyzing a wishing category of the user's wishing message, and issuing the user's wishing message to a region range of the corresponding current location information; and
a merchant's equipment end, receiving the user's wishing message in the region range according to the wishing category, and transmitting a merchant's feedback message to the server according to the user's wishing message;
wherein, the server receives the merchant's feedback message, and transmits the merchant's feedback message to the user's equipment end, and the user's equipment end receives the merchant's feedback message through the server to automatically guide the user to a position corresponding to merchant's location information of the merchant's equipment end.

2. The service system of claim 1, wherein the merchant's feedback message includes a merchant address or a merchant map of the merchant's location information.

3. The service system of claim 1, wherein the user's equipment end computes a navigation route according to the current location information and the merchant's location information to provide the navigation route to the user.

4. The service system of claim 1, wherein the user's equipment end receives a user's input selected from a collection of a willing-to-pay amount, a distance of the current location information, a predetermined time, a desired wish, and any combination of the above.

5. The service system of claim 4, wherein the merchant's equipment end determines to transmit the merchant's feedback message to the server according to the user's equipment end's willing-to-pay amount, distance of the current location information, predetermined time, desired wish or any combination of the above.

6. The service system of claim 1, wherein the merchant's equipment end receives a merchant's activity message inputted by a merchant, and transmits the merchant's activity message and the merchant's location information to the server.

7. The service system of claim 6, wherein the server receives the merchant's activity message, and analyzes the wishing category of the merchant's activity message to issue the merchant's activity message to the region range corresponding to the merchant's location information.

8. The service system of claim 6, wherein the user's equipment end receives the merchant's activity message within the region range according to the wishing category, and transmits a user's willing-to-participate message to the server according to the merchant's activity message.

9. The service system of claim 8, wherein the server receives the user's willing-to-participate message inputted by the user's equipment end and transmits the user's willing-to-participate message to the merchant's equipment end, and the merchant's equipment end receives the user's willing-to-participate message through the server and provides the user's willing-to-particulate message to the merchant's equipment end to calculate statistics of a user's willingness.

10. A wishing service method, applied in a location-based service system, and the service system comprising a user's equipment end, a server and a merchant's equipment end, and the wishing service method comprising the steps of:
providing a current location information of the user's equipment end received through a global positioning system;
receiving a user's wishing message inputted by a user through the user's equipment end;
transmitting the current location information and the user's wishing message from the user's equipment end;
receiving the current location information of the user's equipment end and the user's wishing message by the server;
analyzing a wishing category of the user's wishing message through the server;
issuing the user's wishing message to a region range of the corresponding current location information through the server;
receiving the user's wishing message within the region range and providing the user's wishing message to the merchant's equipment end according to the wishing category;
transmitting a merchant's feedback message to the server from the merchant's equipment end according to the user's wishing message;
transmitting the merchant's feedback message to the user's equipment end through the server; and
receiving the merchant's feedback message by the user's equipment end to automatically guide the user to a position corresponding to merchant's location information of the merchant's equipment end.

11. The wishing service method of claim 10, wherein the merchant's feedback message includes a merchant address or a merchant map of the merchant's location information.

12. The wishing service method of claim 10, further comprising the step of:
calculating a navigation route according to the current location information and the merchant's location information through the user's equipment end, and providing the navigation route to the user.

13. The wishing service method of claim 10, further comprising the step of:
receiving a user input selected from a collection of a willing-to-pay amount, a distance of the current location information, a predetermined time, a desired wish, and any combination of the above by the user's equipment end.

14. The wishing service method of claim 13, further comprising the step of:
determining whether to transmit the merchant's feedback message to the server by the merchant's equipment end according to the willing-to-pay amount, the distance of the current location information, the predetermined time, the desired wish or any combination of the above of the user's equipment end.

15. The wishing service method of claim 10, further comprising the step of:
receiving a merchant's activity message inputted by a merchant through the merchant's equipment end; and
transmitting the merchant's activity message and the merchant's location information to the server through the merchant's equipment end.

16. The wishing service method of claim 15, further comprising the step of:
receiving the merchant's activity message by the server; and
analyzing the wishing category of the merchant's activity message by the server to issue the merchant's activity message to the region range of the corresponding merchant's location information.

17. The wishing service method of claim 15, further comprising the steps of:
receiving the merchant's activity message within the region range by the user's equipment end according to the wishing category; and
transmitting a user's willing-to-participate message to the server according to the merchant's activity message through the user's equipment end.

18. The wishing service method of claim 17, further comprising the steps of:
receiving the user's willing-to-participate message inputted by the user's equipment end by the server;
transmitting the user's willing-to-participate message to the merchant's equipment end through the server; and
receiving the user's willing-to-participate message from the merchant's equipment end through the server and providing the user's willing-to-participate message to the merchant's equipment end to calculate statistics of a user's willingness.
